(19) United States
(12) Patent Application Publication
(10) Pub. No.: US 2015/0120415 A1
(43) Pub. Date: Apr. 30, 2015

(54) MARKETING BASED ON PRODUCTS IDENTIFIED IN DIGITAL MEDIA

(71) Applicant: International Business Machines Corporation, Armonk, NY (US)

(72) Inventors: Yuk L. Chan, Poughkeepsie, NY (US); Christopher Cramer, Troy, NY (US); Robert G. King, Longmont, CO (US); Deepti M. Naphade, Fishkill, NY (US); Jairo A. Pava, Wappingers Falls, NY (US)

(21) Appl. No.: 14/501,193

(22) Filed: Sep. 30, 2014

Related U.S. Application Data
(63) Continuation of application No. 14/067,118, filed on Oct. 30, 2013.

(51) Int. Cl. G06Q 30/02; G06Q 50/00

(52) U.S. Cl. CPC G06Q 30/0269; G06Q 30/0259; G06Q 30/0242; G06Q 30/0214; G06Q 30/0257; G06Q 30/0254; G06Q 50/01
USPC 705/14.16; 705/14.66; 705/14.57; 705/14.41; 705/14.55

(57) ABSTRACT

In an exemplary embodiment, a computer-implemented method includes identifying at least a portion of an image as a taggable product appearing in the image. A tag is generated, by a computer processor, for the taggable product. The tag is associated with the identified portion of the image and includes information about the taggable product, where generating the tag converts the taggable product into a tagged product. A first ad is prioritized over a plurality of other ads for display on a web page in conjunction with the image, where the prioritization is based at least in part on the first ad being related to the tagged product.

### DOMESTIC PRIORITY

This application is a continuation of U.S. patent application Ser. No. 14/067,118, filed Oct. 30, 2013, the disclosure of which is incorporated by reference herein in its entirety.

### BACKGROUND

Various embodiments of this disclosure relate to product marketing and, more particularly, to targeted marketing for products identified as appearing in digital media.

Social networking sites, such as Facebook™, allow users to identify people in photographs. Such an identification results in a tag, which indicates that a specific person appears in a specific photo. For instance, after a photo is uploaded to Facebook, the user who uploaded the photo may associate a section of the photo with a person's Facebook profile, thus “tagging” that person in the photo. The photo then appears on the tagged person's profile, indicating that the photo contains an image of that tagged person. In some cases, a social networking site can make suggestions as to which people might appear in a photo, based on image analysis and previous identifications.

In some cases, social networking sites also display advertisements in the sidebars. Minimal targeting is used to provide these ads, and as a result, the ads are not as successful as would be desired.

### SUMMARY

In one embodiment of this disclosure, a computer-implemented method includes identifying at least a portion of an image as a taggable product appearing in the image. A tag is generated, by a computer processor, for the taggable product. The tag is associated with the identified portion of the image and includes information about the taggable product, where generating the tag converts the taggable product into a tagged product. A first ad is prioritized over a plurality of other ads for display on a web page in conjunction with the image, where the prioritization is based at least in part on the first ad being related to the tagged product.

In another embodiment, a machine-implemented system includes a tagging unit configured to identify at least a portion of an image as a taggable product appearing in the image; and generate a tag for the taggable product, the tag being associated with the identified portion of the image and comprising information about the taggable product, where generating the tag converts the taggable product into a tagged product.

In yet another embodiment, a computer program product includes a computer readable storage medium having computer readable program code embodied thereon. The computer readable program code is executable by a processor to perform a method. The method includes identifying at least a portion of an image as a taggable product appearing in the image. Further according to the method, a tag is generated, by a computer processor, for the taggable product. The tag is associated with the identified portion of the image and includes information about the taggable product, where generating the tag converts the taggable product into a tagged product. A first ad is prioritized over a plurality of other ads for display on a web page in conjunction with the image, where the prioritization is based at least in part on the first ad being related to the tagged product.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE SEVERAL VIEWS OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1 is a block diagram of a computing device for implementing some or all aspects of a marketing system, according to an exemplary embodiment of this disclosure;

FIG. 2 is a block diagram of the marketing system, according to an exemplary embodiment of this disclosure; and

FIG. 3 is a flow diagram of a method for providing targeted marketing based on a tag in a photo, according to an exemplary embodiment of this disclosure.

### DETAILED DESCRIPTION

Various embodiments of this disclosure provide targeted marketing based on products that are tagged in digital media, such as photographs. Product-tagging may enable users to endorse items appearing in their photos, such as branded shoes or clothing. An exemplary marketing system may suggest tags for products in a photo, and the user may accept one or more of the suggested tags or supply his own. After the tagging is performed, a resulting tag may announce the identity of the product to those who view the photo. The product's manufacturer or vendor may make use of the tag, or ad providers may select ads for display based on which tagged products are in the photo.

As a result of product-tagging, a user can play a role in product endorsement or marketing. Others having access to the tagged photo may have similar taste in products. Specifically, those on the user's friends list will often have characteristics in common with the user (e.g., age group, culture, education, employer, race, country of origin, etc.), so marketing through product-tagging may be more targeted and personal than traditional web-based advertising.

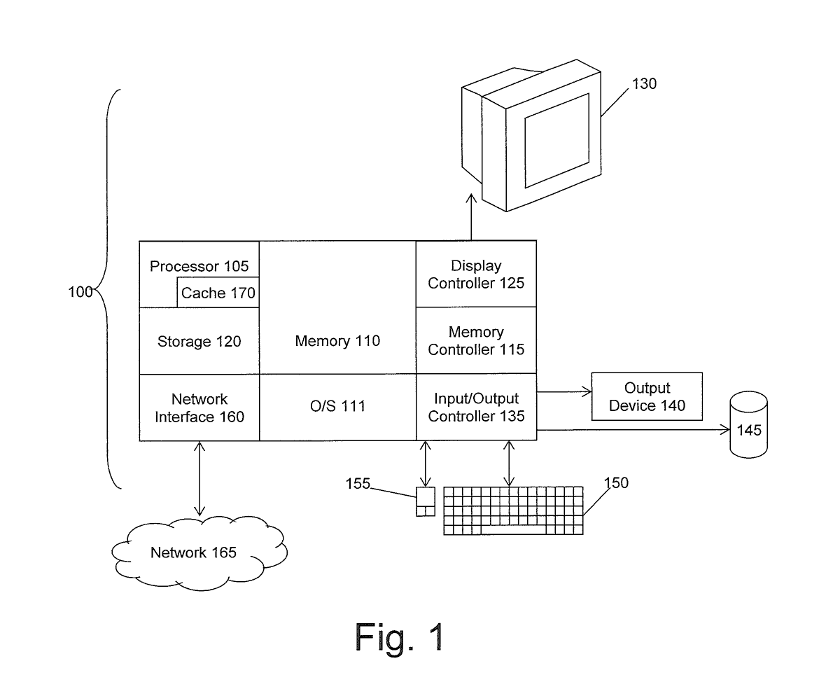

FIG. 1 illustrates a block diagram of a computer system 100 for use in implementing a marketing system or method according to some embodiments. The marketing systems and methods described herein may be implemented in hardware, software (e.g., firmware), or a combination thereof. In an exemplary embodiment, the methods described may be implemented, at least in part, in hardware and may be part of the microprocessor of a special or general-purpose computer system 100, such as a personal computer, workstation, minicomputer, or mainframe computer.

In an exemplary embodiment, as shown in FIG. 1, the computer system 100 includes a processor 105, memory 110 coupled to a memory controller 115, and one or more input and/or output (I/O) devices 140 and 145, such as peripherals, that are communicatively coupled via a local I/O controller 135. The I/O controller 135 may be, for example but not limitation, one or more buses or other wired or wireless connections, as are known in the art. The I/O controller 135 may have additional elements, which are omitted for simplicity, such as controllers, buffers (caches), drivers, repeaters, and receivers, to enable communications.

The processor 105 is a hardware device for executing hardware instructions or software, particularly those stored in memory 110. The processor 105 may be any custom made or commercially available processor, a central processing unit (CPU), an auxiliary processor among several processors associated with the computer system 100, a semiconductor based microprocessor (in the form of a microchip or chip set), a macroprocessor, or other device for executing instructions. The processor 105 includes a cache 170, which may include, but is not limited to, an instruction cache to speed up executable instruction fetch, a data cache to speed up data fetch and store, and a translation lookaside buffer (TLB) used to speed up virtual-to-physical address translation for both executable instructions and data. The cache 170 may be organized as a hierarchy of more cache levels (L1, L2, etc.).

The memory 110 may include any one or combinations of volatile memory elements (e.g., random access memory, RAM, such as DRAM, SRAM, SDRAM, etc.) and nonvolatile memory elements (e.g., ROM, erasable programmable read only memory (EPROM), electronically erasable programmable read only memory (EEPROM), programmable read only memory (PROM), tape, compact disc read only memory (CD-ROM), disk, diskette, cartridge, cassette or the like, etc.). Moreover, the memory 110 may incorporate electronic, magnetic, optical, or other types of storage media. Note that the memory 110 may have a distributed architecture, where various components are situated remote from one another but may be accessed by the processor 105.

The instructions in memory 110 may include one or more separate programs, each of which comprises an ordered listing of executable instructions for implementing logical functions. In the example of FIG. 1, the instructions in the memory 110 include a suitable operating system (OS) 111. The operating system 111 essentially may control the execution of other computer programs and provides scheduling, input-output control, file and data management, memory management, and communication control and related services.

Additional data, including, for example, instructions for the processor 105 or other retrievable information, may be stored in storage 120, which may be a storage device such as a hard disk drive.

In an exemplary embodiment, a conventional keyboard 150 and mouse 155 may be coupled to the I/O controller 135. Other output devices such as the I/O devices 140 and 145 may include input devices, for example but not limited to, a printer, a scanner, a microphone, and the like. The I/O devices 140, 145 may further include devices that communicate both inputs and outputs, for instance but not limited to, a network interface card (NIC) or modulator/demodulator (for accessing other files, devices, systems, or a network), a radio frequency (RF) or other transceiver, a telephonic interface, a bridge, a router, and the like.

The computer system 100 may further include a display controller 125 coupled to a display 130. In an exemplary embodiment, the computer system 100 may further include a network interface 160 for coupling to a network 165. The network 165 may be an IP-based network for communication between the computer system 100 and any external server, client and the like via a broadband connection. The network 165 transmits and receives data between the computer system 100 and external systems. In an exemplary embodiment, the network 165 may be a managed IP network administered by a service provider. The network 165 may be implemented in a wireless fashion, e.g., using wireless protocols and technologies, such as WiFi, WiMax, etc. The network 165 may also be a packet-switched network such as a local area network, wide area network, metropolitan area network, the Internet, or other similar type of network environment. The network 165 may be a fixed wireless network, a wireless local area network (LAN), a wireless wide area network (WAN) a personal area network (PAN), a virtual private network (VPN), intranet or other suitable network system and may include equipment for receiving and transmitting signals.

Marketing systems and methods according to this disclosure may be embodied, in whole or in part, in computer program products or in computer systems 100, such as that illustrated in FIG. 1.

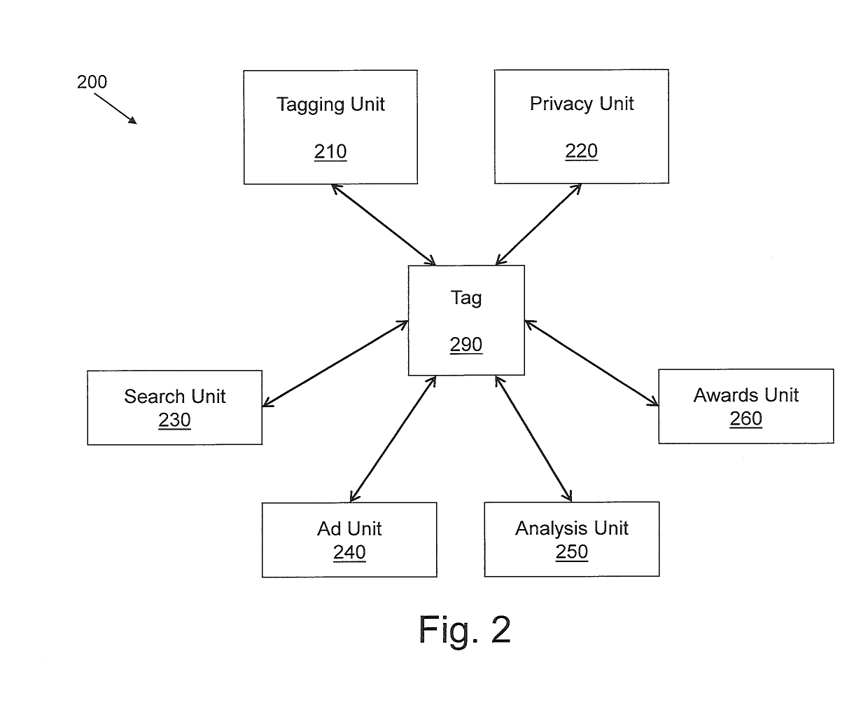

FIG. 2 is a block diagram of a marketing system 200, according to an exemplary embodiment of this disclosure. As shown, the marketing system 200 may include a tagging unit 210, a privacy unit 220, a search unit 230, an ad unit 240, an analysis unit 250, and an awards unit 260. Generally, the tagging unit 210 may generate tags 290 for products appearing in digital media. The privacy unit 220 may determine whether and by whom those tags 290 are visible. The various other units of the marketing system 200 may then use the tags 290 to provide targeted marketing.

In an exemplary embodiment, the marketing system 200 may run on, be integrated with, or be in communication with a website or system in which users interact with one another. For example, and not by way of limitation, the marketing system 200 may be integrated into a social networking website. Throughout this disclosure, the marketing system 200 is referred to as being used with a social networking website, but it will be understood that the marketing system 200 is not limited to this context. Rather, in the various examples given, the social networking website may be substituted with a different website or system for user interactions.

When digital media, such as a photo, becomes accessible by the marketing system 200, such as by being uploaded to an associated social networking website, the tagging unit 210 may attempt to tag one or more products in the photo. Tagging may occur by various means. For example, a primary user who uploaded or owns the photo may select a portion of the photo that depicts a taggable product, or the marketing system 200 may automatically select taggable products through image analysis or other means. After a taggable product is selected in the photo, the user may enter information about that taggable product, or image analysis or other techniques may be used to identify information about the taggable product. Based on that identification information, the taggable product may then be associated with a tag 290, which identifies the product to viewers of the photo.

A tag 290 may include, for example, one or more of the following information about the newly tagged product: type of product (e.g., hat, car, shoes, beverage), product brand, website representing the brand or vendor of the product, retail price, and sales price. It will be understood that other information about the tagged product may be included in the tag 290, in addition or alternatively to these examples. The information included in the tag 290 may be acquired through various means. For example, and not by way of limitation, the information may be entered by the primary user or another user, or it may be found through a web search conducted by the tagging unit 210.

A tag may also include an indication of the owner of the tagged product. The tagging unit 210 may assign ownership of a tagged product to either the primary user or to another user. A product appearing a photo is likely to be owned by some individual or group, and the owner may or may not be the primary user (i.e., the user deemed to own the photo). Accordingly, the primary user or other user requesting the tag, or requesting modification of the tag, may indicate to the tagging unit 210 who the owner of the tagged product is. In some embodiments, the tagging unit 210 may determine or suggest ownership assignments based on the various users who are tagged in the photo in which the tagged object appears. For example, if the photo's tags indicate that it shows the primary user, a second user, and the tagged product, the tagging unit 210 may determine which of the two users is closer in proximity to or is touching the tagged product in the photo. Whichever use appears to have the strongest physical connection to the tagged product may be deemed to be the tagged product's owner, unless the primary user indicates otherwise. If ownership assigned, then the tag for the tagged product may also include a link to the owner's user profile.

In some embodiments, various users of the social networking site may be enabled to indicate their approval or disapproval of tagged products. This approval or disapproval may be distinct from approval or disapproval of the photos in which the tagged products appear. For example, and not by way of limitation, when a user views a photo with a tagged product, the user may select a link, button, or other object to indicate that he likes or otherwise approves of the tagged object. A separate link, button, or other object may be provided to indicate approval of the entire photo. Additionally, in some embodiments, the user may also indicate his dislike, or other form of disapproval, of the tagged object.

Users' indications of approval or disapproval may be associated with the users' profiles and may be used by the marketing system 200 to determine product preferences. For example, and not by way of limitation, the marketing system 200 may recommend products to a user based on that user's history of approvals and disapprovals for tagged products.

In an exemplary embodiment, a tag 290 associated with a tagged product may include a link to a profile, if one exists, of an invested entity that has some stake in the sales success of the tagged product. For example, and not by way of limitation, the invested entity may be the tagged product's brand, vendor, retailer, or manufacturer. If the product tag 290 is linked to the profile of an invested entity, the tagged product may be thereby associated with the invested entity on the social networking site. As a result of the tag 290, the photo may appear on the invested party's profile. The photo may also appear on the primary user's profile, as well as the profiles of one or more other users who are tagged in the photo.

The privacy unit 220 may determine where and when the photo appears on various profiles of the social networking site. The privacy unit 220 may present each user with a mechanism for setting privacy preferences. Through this mechanism, the user can indicate to the privacy unit 220, for example: whether or by whom that user may be tagged in others' photos, whether products belonging to that user (e.g., worn or carried by the user) may be tagged in others' photos or may be tagged by other people, and whether photos with tagged products of that user may be associated with that user's profile. Additionally, the user may provide filters indicating which users may see tags 290 for that user's products, or which users may see the photos with such tags 290. These privacy filters may be general to all users or may be based on various characteristics of other users (e.g., friendship status, geographic location, age), and may indicate sets of users for which a photo may be viewable. For example, and not by way of limitation, a first user's privacy settings may indicate that a tag 290 for a product owned by the first user is not visible to anyone other than the first user's friends, even if the photo itself is viewable to the public. In another example, the first user may indicate that any photo in which a product owned by the first user is tagged may only be viewable by his friends.

In some cases, the profile of an invested entity may be controlled and associated with an invested user. In some other cases, however, the invested entity's profile may be community managed and not controlled or administrated by a particular user of the social networking site. If the invested entity is associated with an invested user, then the privacy unit 220 may enable that invested user to manage the privacy settings for the invested entity's profile. Such settings may allow the same or similar options allowed to other users. For example, and not by way of limitation, the invested user may indicate whether its associated products (i.e., products in which the invested entity has some stake) may be tagged by others, whether or to whom such tags 290 are visible, and whether photos with such tags 290 are associated with the invested entity's profile.

A photo showing a tagged product may be associated with a user in various ways. For example, the primary user who owns or uploaded the photo in which the tagged product appears may be associated with the photo of that tagged product. One or more other users tagged in the photo, or owning products in the photo, may be associated with the photo. An invested entity with a stake in the tagged product may also be associated with the tagged product and, therefore, with the photo. Together, the privacy settings of one or more of these associated users may determine to whom and when the photo is displayed on the social networking site.

Additionally, in some embodiments, a government entity or other entity with security concerns may control privacy settings related to a taggable products. For example, a user associated with a government entity profile may indicate that a tag 290 should be hidden or that an entire photo showing a tagged product should be hidden. This feature may be beneficial when the government entity seeks to protect its security interests.

In some cases, the privacy settings of the various users associated with a tagged product may conflict, such as, for example, if the photo owner's privacy settings allow the public to view a photo, but a user owning an item tagged in the photo indicates that only his friends can see such photos. To deal with circumstances such as these, the privacy unit 220 may follow a predetermined set of priority rules to determine when and who may view the photo upon on a conflict of privacy settings. For example, a government entity's settings may be given top priority. After the government entity's concerns have been met, whether the tag 290 is displayed may be determined by the owner of the tagged product, as opposed to the photo's owner. Whether the photo is viewable at all may be determined by the photo owner before the owner of the tagged product. It will be understood that the order of priority is implementation-dependent and may vary between embodiments of the marketing system 200.

After a product is tagged, the search unit 230 of the marketing system 200 may enable users having access to the resulting tag 290 to initiate searches based on the tag 290. When a user views a photo having a tagged product, that user may decide that he or she is interested in learning more about, or purchasing the tagged product. The user can indicate this desire to the marketing system 200 in various ways, such as by selecting the tagged product or selecting a button or link that indicates a request for more information. Upon receiving that indication, the search unit 230 may present the user with one or more online locations for purchasing the product or learning more about the product. In an exemplary embodiment, the search unit 230 may perform a web search, or other data search using accessible data, for sales of the product and may present purchase links or other information to the user.

If the tagged product has various available options (e.g., a shirt that can be purchased in various sizes or colors), the search unit 230 may enable the user to select the desired options and, in some embodiments, the search unit 230 may also make suggestions for certain options based on the user's history. For example, if the user appears in many photos with tagged products that are a certain color, the search unit 230 may suggest that color as an option. When one or more options are selected applicable to the tagged product, the search unit 230 may search specifically for versions of the product with those options.

In some cases, the marketing system 200 may have information relating to the user's clothing size. This information can come from various sources. For example, this information may have been entered by the user into the social networking site, and may therefore be accessible by the marketing system 200. In some embodiments, when the user tags products in photos, or otherwise provides information to assist in tagging, such tags 290 may indicate the sizes of tagged products owned by the user. The marketing system 200 may therefore access those sizes. If the marketing system 200 has information relating to the user's clothing size, the search unit 230 may use this size information when searching for product pages or locations where the user can purchase the tagged product.

The inclusion of tags 290 from products in photos may provide some advertisement opportunities not previously available. Thus, in some embodiments, the ad unit 240 may select ads for display on the same page, or pages associated with, a photo having a tagged product. These ads may be chosen, at least in part, because they are deemed to be of interest to those who might be viewing the tagged product. The ads may come from various sources. For example, and not by way of limitation, ads may be drawn from a database of retailer advertisements or product advertisements, may be generated automatically, or may be manually inputted by system administrators. For example, an automatically generated ad may be an endorsement where the user is presented with an ad related to the retailer, along with an automatically generated endorsement based on the owner of the tagged product. Such an endorsement in an automatically generated ad may be, for example: “Your friend Patrick likes this retailer and has bought at least 10 shirts from this retailer.”

For example, if a current page being viewed or loaded onto the social networking site contains a photo having a tagged product that is a first type of product, the ad unit 240 may select ads for that current page that are also for that first type of product. Alternatively, the ads chosen may be for products or services related to that type of product, or for products or services that are deemed to be attractive to those who have interest in the tagged product. In other words, the ad unit 240 may make ad selections based on the specific products tagged in the photo. The assumption here is that those who are viewing the photo may have interest in the tagged product, and thus may have also have interest in services and products with some relationship to the tagged product. That shared relationship between the tagged product and a selected advertised product or service may take various forms. For example, the tagged product and advertised product or service may come from a shared retailer or may share a brand, color, or other product or service characteristic.

The analysis unit 250 may monitor and analyze product-tagging of the various users associated with the social networking site. The analysis unit 250 may have access to various information about the users, which information may be provided through the social networking site or other means. It is likely that the various user profiles of the social networking site already include detailed information about the respective users, including, for example, age, race, nationality, geographic location, employer, religion, and hobbies. Some of this information may not be otherwise available to product sellers, but may be used for the benefit of these product sellers according to some exemplary embodiments.

When a product is tagged, the analysis unit 250 may see the associations between the tagged product and users associated with the photo. These associations may include, for example, an association between the tagged product and the one or more users deemed to own the tagged product, and an association between the tagged product and users who view or indicate approval of the tagged product. Accordingly, the analysis unit 250 may draw connections between users and certain types of products. Through these connections, the analysis unit 250 may make assumptions about types of products a user might like or might purchase. These assumptions with respect to particular user may be based on, for example: the products in photos associated with the user; the products appearing to be owned by the user in photos; the product tags 290 viewed or selected by the user; the products associated with users having characteristics (e.g., age, location, interests) in common with the user; or products associated with the user's friends, who likely have common interests with the user.

These tag-based statistics and assumptions may be used in various ways. For example, and not by way of limitation, statistics or assumptions about a user or a class of users may be sold to advertisers or data compilers for their use. In another example, the statistics or assumptions may be used to provide targeted marketing with increased likelihood of success. As discussed above, targeted ads may be placed on web pages displaying photos with tagged products. Selections of such ads may be based on the statistics and assumptions made by the analysis unit 250, thus providing further improved marketing results.

Various incentives might by inherent in some embodiments of the marketing system 200, and some other incentives may be provided by the awards unit 260. An inherent incentive, for example, may be that users can become aware of what products their friends are using. As friends often have common interests, a user may discover products he or she enjoys based on friends' product tags 290. Some embodiments of the marketing system 200 may provide to users statistics related to a tagged product. For example, and not by way of limitation, when a first user views a friend's photo having a particular tagged product, the marketing system 200 may, on that same web page, indicate how many friends appear in photos with the same or a similar product. Further, knowing that this type of information is available may encourage users to tag products in their own photos.

In some embodiments, the marketing system 200 may provide additional incentives for product-tagging. In many cases, it is in an invested entity's best interest for its products to be tagged in users' photos. Such tagging can be seen as an endorsement for these products or, at least, may spread knowledge about those products. Thus, the marketing system 200 may enable the invested entity to offer incentives, such as product or service discounts, in return for tagging the invested entity's products. For example, and not by way of limitation, each time a user tags a product associated with the invested entity, that user may earn loyalty points or rewards points that may be exchanged for products or services.

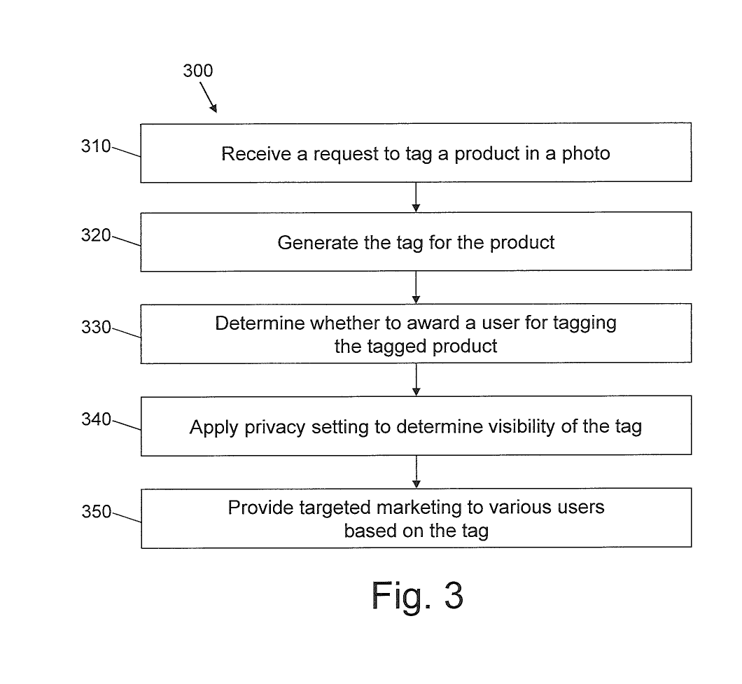

FIG. 3 is a flow diagram of a method 300 for targeted marketing based on a product tag 290, according to an exemplary embodiment of this disclosure. As shown at block 310, a tag request is received from a first user for a taggable object appearing in a photo. At block 320, a tag 290 is generated for the taggable object. At block 330, it is determined whether the first user qualifies for an award based on the tag 290, and if so, an award is provided. At block 340, privacy settings are applied to the tag 290 to determine whether and by whom the tag is viewable. At block 350, various forms of targeted marketing to various users may occur based on the tag 290. For example, and not by way of limitation, product links may be provided indicating where the tagged product can be purchased; ads may be displayed in association with the photo, where the ads are selected based on the tagged product; or statistics may be gathered based on the tag 290, and such statistics may be sold to third parties for their own marketing purposes. It will be understood that various other activities may be based on product tags provided by the various embodiments of this disclosure.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the invention for various embodiments with various modifications as are suited to the particular use contemplated.

Further, as will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, radio frequency (RF), etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method comprising:
identifying at least a portion of an image as a taggable product appearing in the image; and
generating, by a computer processor, a tag for the taggable product, the tag being associated with the identified portion of the image and comprising information about the taggable product, wherein generating the tag converts the taggable product into a tagged product.

2. The method of claim 1, further comprising:
prioritizing a first ad over a plurality of other ads for display on a web page in conjunction with the image based at least in part on the first ad being related to the tagged product.

3. The method of claim 1, further comprising:
gathering statistics related to tagging of the tagged product in other images; and
providing targeted marketing related to the tagged product based on the gathered statistics.

4. The method of claim 3, further comprising:
prioritizing a first ad over other ads for display on a web page in conjunction with the image based at least in part on the statistics related to tagging of the tagged product in the other images.

5. The method of claim 1, wherein generating the tag comprises including in the tag a location where the tagged product is purchasable.

6. The method of claim 1, wherein the image is associated with a first user, the method further comprising:
enabling a second user to indicate approval of the tagged product; and
gathering statistics related to approvals of the tagged product.

7. The method of claim 6, further comprising:
recommending a second product to the second user based on the second user's approval of the tagged product.

8. The method of claim 6, wherein prioritizing a first ad over a plurality of other ads is based at least in part on the statistics related to the approvals for the tagged product.

9. The method of claim 1, further comprising:
associating the image with a first user profile that is deemed to own the image; and
associating the tagged product with an invested entity profile, wherein the invested entity profile represents a provider of the tagged product, and wherein the first user profile is distinct from the invested entity profile;
wherein generating the tag comprises linking the tagged product to the invested entity profile.

10. The method of claim 9, further comprising:
providing a reward to the first user profile from the invested entity profile for tagging the tagged product.

11. The method of claim 9, further comprising:
determining visibility of the tag for the tagged product based at least in part on a privacy setting of the first user profile and a privacy setting of the invested entity profile.

12. The method of claim 1, wherein the image is associated with a first user, the method further comprising:
receiving an indication that a second user is interested in locating the tagged product;
receiving a selection of one or more options related to the tagged product, wherein the tagged product is variable based on the selected options; and
searching for a purchase location for the tagged product with the selected options.

13. The method of claim 1, wherein the image is associated with a first user that is deemed to own the image, the method further comprising:
generating a plurality of tags for the tagged product in a plurality of other images;
gathering statistics related to the plurality of tags for the tagged product; and
notifying a second user of the statistics related to the plurality of tags for the tagged product.

14. The method of claim 1, wherein the image is associated with a first user profile that is deemed to own the image, the method further comprising:
assigning ownership of the tagged product to a second user profile that is distinct from the first user profile; and
associating the image with the second user profile in response to the assignment of ownership.

15. The method of claim 1, further comprising:
awarding an incentive to a first user for tagging the tagged product in the image.

16. A computer program product comprising a computer readable storage medium having computer readable program code embodied thereon, the computer readable program code executable by a processor to perform a method comprising:
identifying at least a portion of an image as a taggable product appearing in the image;
generating a tag for the taggable product, the tag being associated with the identified portion of the image and comprising information about the taggable product, wherein generating the tag converts the taggable product into a tagged product.
